(19) United States
(12) Patent Application Publication
(10) Pub. No.: US 2008/0183561 A1
(43) Pub. Date: Jul. 31, 2008

(54) Marketplace for interactive advertising targeting events

(75) Inventors: Meir Zohar, Givat Shmuel (IL); Elad Efraim, New York, NY (US)

Correspondence Address: SHEEHAN PHINNEY BASS & GREEN, PA;c/o PETER NIEVES, 1000 ELM STREET, MANCHESTER, NH, 03105-3701, US

(73) Assignee: eXelate Media Ltd., Kiryat Matalon (IL)

(21) Appl. No.: 12/019,379

(22) Filed: Jan. 24, 2008

Related U.S. Application Data
(60) Provisional application No. 60/886,679, filed on Jan. 26, 2007.

(51) Int. Cl. G06Q 10/00

(52) U.S. Cl. 705/10

(57) ABSTRACT

A system and method for providing a targeting event marketplace is provided. Generally, the method contains the steps of: at least one targeted publisher and a targeting event marketplace entity agreeing to financial terms associated with revenues received from at least one buyer that obtains access to the Internet browser of an end-user; providing an end-user tag on a Web page of the Web site, wherein the end-user tag is capable of calling a Web server from an Internet browser of the end-user; analyzing an end-user action associated with the Web page, wherein the step of analyzing is performed to categorize the action into a category of targeting event; the Web server determining if at least one buyer has interest in at least one end-user taking an action that is categorized into at least one category of targeting event; and receiving bids from at least one buyer for providing access to the Internet browser of the end-user and selecting at least one buyer.

### CROSS-REFERENCE TO RELATED APPLICATION

This application claims priority to copending U.S. Provisional Application entitled, “Marketplace for Interactive Advertising Targeting Data,” having Ser. No. 60/886,679 filed Jan. 26, 2007, which is entirely incorporated herein by reference.

### FIELD OF THE INVENTION

The present invention is generally related to advertising services, and more particularly is related to an Internet based interactive targeting event marketplace.

### BACKGROUND OF THE INVENTION

Advertising via use of the Internet has become a very large industry. To advertise to individuals most likely to purchase their products or services, advertisers spend significant funds. In addition, Internet Web site owners seek to maximize return from advertisers that are allowed to advertise on their Web sites. Behavioral targeting is one area that has assisted in maximizing return in the advertiser/Web site owner relationship.

Presently, if a Web site owner would like to work with multiple behavioral targeting entities that provide behavioral analysis of individuals viewing their Web site, the owner of the Web site would contact each of the behavioral targeting entities and seek the building of relationships with these entities one by one. An example of such a Web site is a travel Web site such as Expedia®.

The gathered behavioral analysis data specific to the Web site, which is specific to individuals that have visited the Web site, may then be stored by the multiple behavioral targeting entities. Such information is stored and gathered as cookies for use in, for example, providing targeted advertisement to the individuals. For providing such information, the owner of the Web site would receive funds from the targeting entities, while such information is later used by the targeting entities for targeted advertising.

Behavioral targeting is gaining popularity among on-line advertisers, however, there are basic obstacles that prevent behavioral targeting from materializing to its full potential. Current aspects of behavioral target that prevent materializing to full potential include, but are not limited to, conceived privacy infringement, limited integration with existing serving systems, a lack of infrastructure that enables the various entities to form beneficial partnerships, and weak publishers diagnostic abilities.

Regarding conceived privacy infringement, behavioral targeting is based on tracking behavioral elements, such as visited sites and searched keywords, and building a profile on each of the users that describes his or her interests and personal qualities. Unfortunately, as users gain an understanding of this concept there is a growing concern and dislike of this conduct. These negative feelings militate against many of the publishers and other information owners from cooperating with the behavioral targeting entities, resulting in difficulty in acquiring information and less effective results.

With regard to the limited integration with existing serving systems, online ad serving systems have developed certain unique optimization algorithms that enable them to better extract the income potential of the advertising media. Unfortunately, behavioral targeting systems of today have failed to fully integrate with these serving systems and therefore, many of the advantages that lie in the algorithms of the serving system are not materializing.

Regarding the lack of infrastructure that enables the various entities to form beneficial partnerships, behavioral targeting is used today by each of the entities, mostly in a closed loop. Therefore, there is very little cooperation and sharing of information and this can be attributed to the poor integrability offered by behavioral targeting systems of today.

With regard to the weak publishers diagnostic abilities, current approaches do not enable publishers to automatically determine the relevancy of the sites to a given end-user. Current approaches also make it very difficult to identify changes in time of that relevance due to fraud or just changing profile of users.

Thus, a heretofore unaddressed need exists in the industry to address the aforementioned deficiencies and inadequacies.

### SUMMARY OF THE INVENTION

Embodiments of the present invention provide a system and method for providing a targeting event marketplace. In this regard, one embodiment of the method, among others, can be broadly summarized by the following steps: a targeted publisher and a targeting event marketplace entity agreeing to financial terms associated with revenues received from at least one buyer that obtains access to the Internet browser of an end-user; providing an end-user tag on a Web page of the Web site, wherein the end-user tag is capable of calling a Web server from an Internet browser of the end-user; analyzing an end-user action associated with the Web page, wherein the step of analyzing is performed to categorize the action into a category of targeting event; the Web server determining if at least one buyer has interest in at least one end-user taking an action that is categorized into at least one category of targeting event; and receiving bids from at least one buyer for providing access to the Internet browser of the end-user and selecting at least one buyer.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram illustrating a general structure of the targeting event marketplace.

FIG. 2 is a block diagram illustrating examples of items stored within the central database of FIG. 1.

FIG. 3A and FIG. 3B are flowcharts illustrating different scenarios in which a process is used for placing a delayed ad cookie on the Internet browser of an end-user.

FIG. 4 is a flowchart illustrating the process of adding additional targeting data to ad serving decision process.

FIG. 5 is a flowchart illustrating steps taken by the present targeting event marketplace to ensure targeting quality of the Web site.

FIG. 6 is a flowchart further illustrating the process of using the present targeting event marketplace in accordance with the first exemplary embodiment of the invention.

### DETAILED DESCRIPTION

The present invention provides an Internet based interactive targeting event marketplace. A detailed description of the system and method associated with the same is provided below. It should be noted, however, that while the present description uses the example of using the present system and method on the Internet, since a Web site is the considered data provider, in accordance with an alternative embodiment of the invention, the data provider may be, for example, but not limited to, software applications that have access to data about the users, Hypertext Markup Language (HTML) components also known as Widgets, and direct marketers that buy targeted data and therefore have monetizeable access to it. The following is specific to the example of the Web site being used as the data provider.

### DEFINITIONS

The following definitions are valuable in review of the present description.

ETEtag: An end-user tag used by the present system and method. The ETEtag is distributed by partners/owners of media, such as, but not limited to, Web sites, software, or Web-based service providers, who are responsible for the distribution. The ETEtag is processed by an end-user Internet browser as part of the Web page that the tag resides on. The ETEtag also communicates with an ETEserver and sends relevant targeting attributes required for delayed-ads. The delayed ad may be, for example, a set of cookies that is written by a certain Serving System on an end-user Internet browser to be used in the future in order to decide which ad to show to a user.
T-pub (targeted publisher) (also referred to as a P-Pub (placement publisher)): Partners/owners of media, such as, but not limited to, Web sites, software, or Web-based service providers, who are responsible for the distribution of ETEtags.
Serving System: An ad delivery platform, used by advertisers and publishers, to display online ads. One example, among many, of an ad delivery platform is the DART system from DoubleClick®, of New York, N.Y.
Network: A company that mediated between a group of sites and advertisers, using a specific serving system. The advertisers are the clients of the network and the sites are suppliers of the Network.
Targeting Element (also referred to as a Targeting Event): A specific attribute identified by end-user Web activity. The attribute can be a URL of a site the end-user was visiting, a keyword used for search, a contextual category of the visited site, or other attributes.
Targeting Channel (also referred to as a category of targeting event): A collection of end-users anonymously identified with high relevancy to a specific vertical market based on their Web activity and the identified targeting elements. Examples of vertical markets may include, but are not limited to, the travel market, the business market, and the shopping market, although other vertical markets may be included.
Targeting Group: A collection of targeting elements with a common association. Each targeting group is associated with a specific targeting channel or campaign.
Pixel: An Internet based request, such as, but not limited to, an HTTP request, such as, but not limited to, an image or a script, that returns a 1×1 transparent image to the end-user browser and updates the end-user cookie with specific targeting data. The term pixel is also referred to herein as a segment pixel or a re-targeting pixel.
Ad Placement: A result of a targeting channel pixel request from a specific serving system. The serving system response creates a cookie record on the end-user Internet browser with the targeting channel data or a delayed ad that may be used with a future ad display. Since the process of creating a cookie on a browser is known to those having ordinary skill in the art as a common targeting method, this process is not described in detail herein. Although reference is made to a delayed ad it is to be understood that any other suitable object may be loaded in an end-user computer to allow an ad server subsequently to determine a preferred type of ad to be redirected to the end-user computer. Specifically, the delayed ad is generally not itself an advertisement but is an indication of an advertisement type that is pre-loaded in a computer for later use by an ad server when serving an ad to that computer.
Campaign: Specific online ads (one or more) for a single product or offer, managed on a serving system and targeted to a specific channel or targeting group.
Reach Percentage: The ratio between the actual ads display count (impressions or ‘imprs’) and the total number of placements on specific serving system and channel.
End-user: A casual Internet surfer that normally visits various Web sites using an Internet browser. The end-user may be anonymous to the present system and method.
Authorized marketplace user: A person, working for one of the entities on the marketplace, who has privileges to use the marketplace system.
Identifier: A coded number used by the system to represent various codes as a single value.

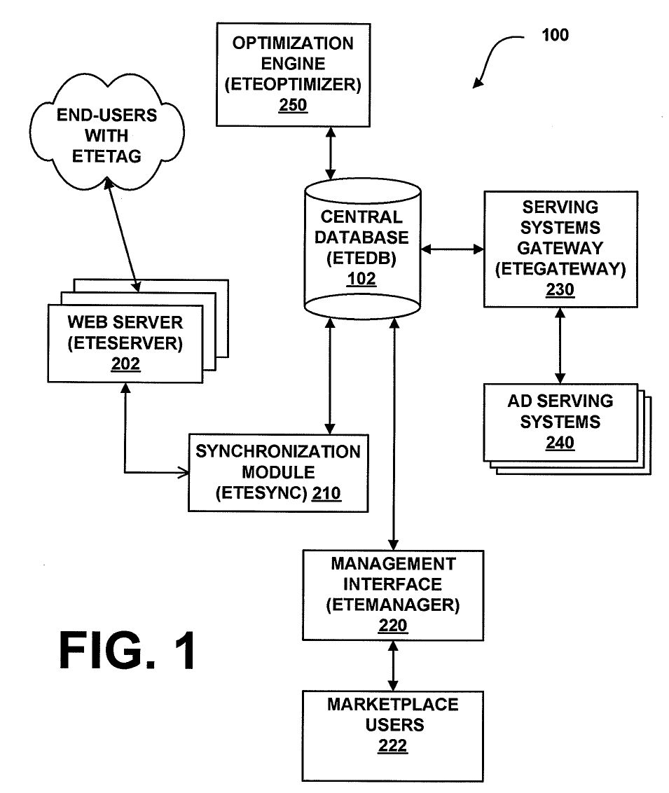

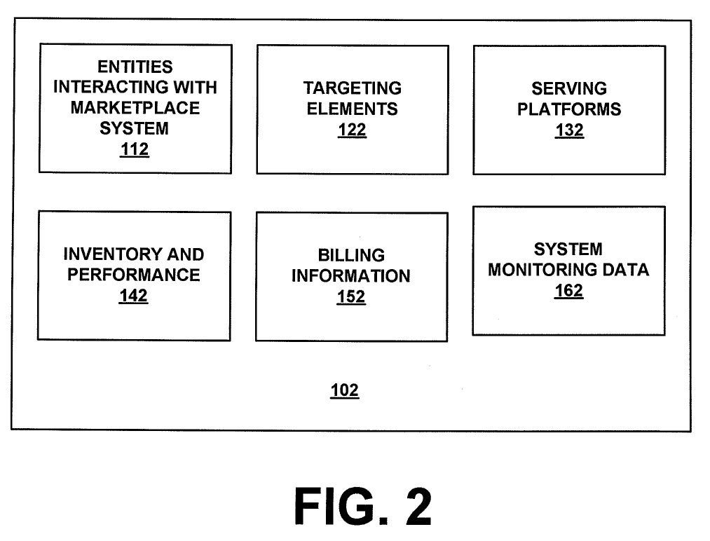

FIG. 1 is a schematic diagram illustrating a general structure of the targeting event marketplace 100. As is shown by FIG. 1, the targeting event marketplace 100 contains a central database 102 (ETEdb). The central database 102 is a central repository for the marketplace system 100. The central database 102 is defined for Online Transaction Processing (OLTP) and is utilized to store items. Examples of items stored within the central database 102 are shown by the schematic diagram of FIG. 2.

As is shown by FIG. 2, the central database 102 stores at least entities 112 interacting with the marketplace system 100, such as, users, advertisers, and publishers. Targeting elements 122, such as, channels, groups, and pixels, may also be stored in the central database 102. Also stored within the central database 102 are serving platforms 132, inventory and performance 142, billing information 152, and system monitoring data 162.

Returning to FIG. 1, the targeting event marketplace 100 contains a targeting Web server (ETEserver) 202. The targeting Web server 202 is a high performance serving array, such as an HTTP server, and serves end-user HTTP calls using an in-memory targeting database. During the process, the targeting Web server 202 analyzes targeting attributes of each end-user and performs delayed ad placement. Delayed ad placement is an update to a third party cookie of an end-user, as part of Internet browser cookies of the end-user, made by an ad serving system 240 once the Web server 202 loads its pixel. The Internet browser of end-users are tagged with the relevant external serving systems 240 pixels (cookie update) and the action is stored in the central database 102 anonymously, within the inventory and performance 142 portion of the central database 102. Specifically, the Web server 202 writes a pixel call back to the end-user browser for each one of the ad serving systems 240. Once the pixel associated with an ad serving system 240 is loaded to the browser of the end-user, the ad serving system updates a cookie on its domain with this targeting indication that it can later use.

With regard to updating an end-user cookie, cookie records of an end-user hold a local repository of targeting events and matching pixels, channels and delayed ads. In addition, it is preferred that the cookie records are updated with each request. The data on the cookie records are used in order to define the uniqueness of the end-user requests (based on frequency of calls) and in order to display to the end-user the delayed ads and channels the marketplace detected (using a dedicated Web page).

The Web server 202 also creates anonymous log records for each end-user request with different details, such as, but not limited to, the following: date and time of visiting a Web site; geolocation; T-pub site location; targeting elements; targeting groups; matching channels; matching targeting pixels; and uniqueness of the request (month,day).

The Web server 202 is capable of extracting and using at least the following targeting elements: T-pub identification, Web site identification, channel identification, and ad group identification; Web page URL; referral Web page URL; geolocation; contextual category (based on text and keywords identified on the Web page); search keywords used by an end-user to obtain any type of Internet search in a search engine; additional targeting attributes, such as, gender, age, and interests; and channel history, and first/previous/last visits timestamp.

A synchronization module (ETEsync) 210 is provided within the targeting event marketplace 100. The synchronization module 210 is responsible for periodic propagation of updates from the central database 102 and the targeting Web server 202 (server array). In addition, the synchronization module 210 is responsible for the processing and aggregation of Web server array logs into the central database 102. It should be noted that different transmission mediums may be used by the synchronization module 210, such as, but not limited to, File Transfer Protocol (FTP) and other common file transfer methods.

As is shown by FIG. 1, the targeting event marketplace 100 also contains a management interface (ETEmanager) 220. The management interface 220 is a Web-based application provided on a Web server and an application server. Alternatively, the Web server and application server may be combined into a single machine. The management interface 220 provides marketplace users 222, such as, but not limited to, account managers (authorized users that manage the T-pub accounts), targeted publishers (T-Pubs), and advertisers, the ability to view, update, and control the targeting activity, inventory, performance, and billing associated with a targeting event marketplace. These abilities are provided by using a Web based management suite that allows each authorized user to login, generate, and review reports and to use custom screens in order to update and create entities/objects on the targeting event marketplace 100. Examples of reports may include, for example, inventory reports, performance reports revenue reports, and channel reports, where channel reports may be anything related to the marketplace activity, revenue or performance by channel.

A serving systems gateway (ETEgateway) 230 is provided within the targeting event marketplace 100. The serving systems gateway 230 links the targeting event marketplace 100 to external ad serving systems 240. By using application programming interfaces (APIs) of serving systems 240, or other integration methods, the serving systems gateway 230 imports performance and targeting data from the serving systems 240, which may be stored in the central database 102, and updates the serving systems 240 with relevant targeting data, from, for example, the central database 102. The targeting data may include, for example, re-targeting pixels and any other targeting element related to the end-user that can contribute to the decision of the ad serving system 240 or predict success in a specific advertising campaign. The ETEgateway 230 implements 2-way data transfer integration with the serving systems 240 in the targeting event marketplace 100. The integration allows the advertisers and networks in each of the serving systems 240 to use the targeting event data offered on the marketplace.

The targeting event marketplace 100 also contains an optimization engine (ETEoptimizer) 250. The optimization engine 250 monitors the marketplace activity in order to optimize the inventory and to increase performance of advertising campaigns. Optimization of inventory may be performed by testing each data provider, such as a Web site, on an ongoing basis, using a testing methodology that will maximize performance of ad campaigns, while removing the non-performing data providers from the targeting event marketplace 100 or by dividing the data providers into separate groups of performance and allowing the buyers to use a different bid price for each performance group or in some cases for each data provider. In addition, it should be noted that the data providers may be ranked, with adjustment to the ranking performed continuously. Inventory performance may be monitored based on real-time and offline reports that include results of ad campaigns that are using targeting events. The targeting event marketplace 100 obtains the reports from the ad serving systems 240 via the API and integration with ad serving systems 240. The optimization engine is a collection of backend processes designed to monitor, analyze and update the central database 102 in order to maximize revenue received through use of the present targeting event marketplace 100, increase the performance of the ad campaigns, and to insure the targeting quality of the targeting channels.

In accordance with one exemplary embodiment of the invention, in order to support a high volume of end-user requests, the targeting event marketplace 100 is based on a three tier serving platform, using, for example, a JavaScript client on the front end, a Web server, and an independent communication layer to synchronize with the central database 102. An example of an independent communication layer may include, but is not limited to a synchronization layer.

It should be noted that each of the components described as being a portion of the targeting event marketplace 100 may be located within separate computers or other devices. In addition, in accordance with an alternative embodiment of the invention, the central database 102, the optimization engine 250, the synchronization module 210, and the systems gateway 230 may be located together within a single server.

The following provides a series of scenarios handled by the present targeting event marketplace 100. It should be noted that the following scenarios are exemplary, and are not intended to limit the number or type of scenarios in which the present targeting event marketplace 100 may be used. For the following exemplary scenarios, the following identifiers are used:

A1 is an ad serving system that provides online advertisements to Web sites;

S1 is a Web site associated with travel, which displays travel information and uses the ETEtag;

S2 is a Web site associated with finance, which displays financial information and uses the ETEtag;

S3 is a general news Web site, which displays news content and general advertisement using ad serving system A1; and

U1 and U2 are first and second end-users, respectfully, that are surfing the Internet and visiting different Web sites.

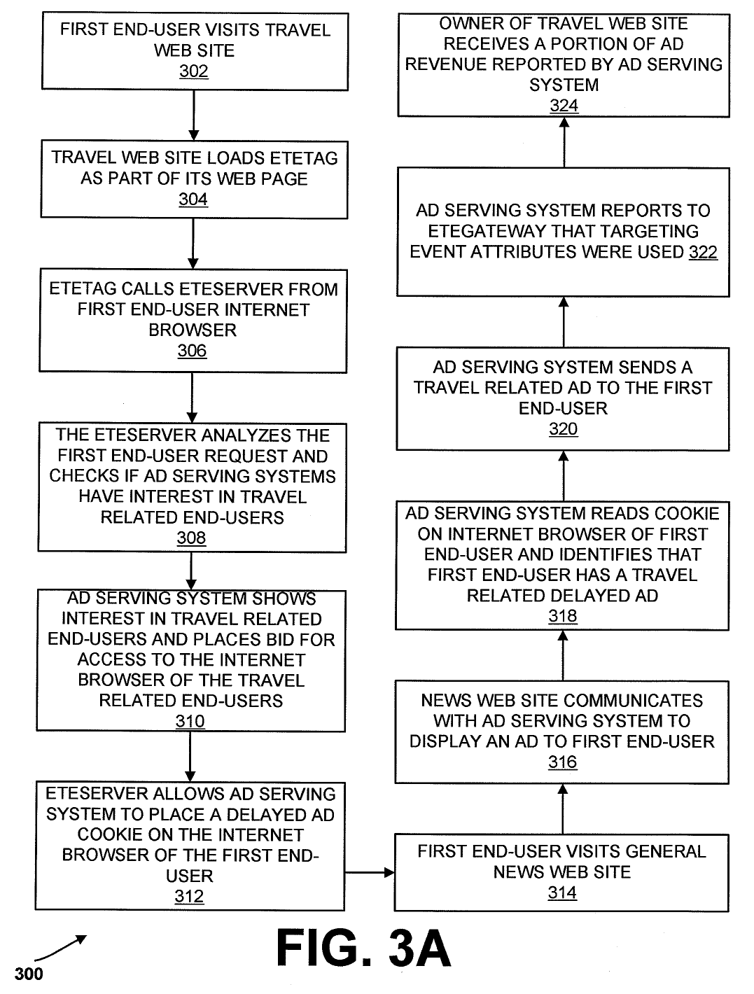

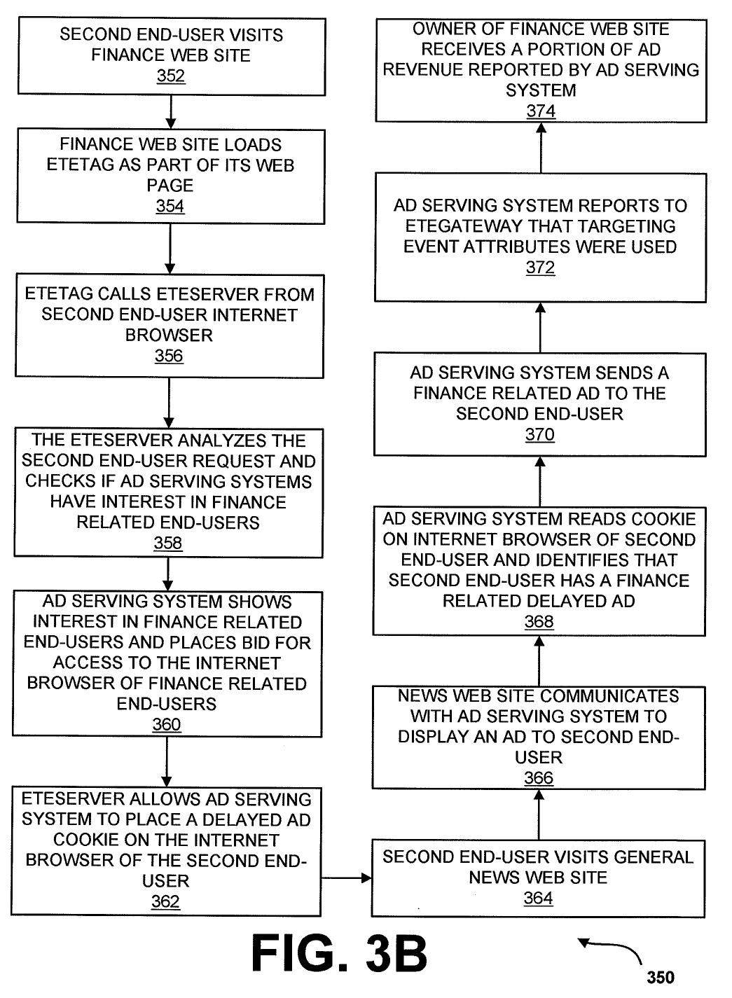

FIG. 3A and FIG. 3B are flowcharts illustrating different scenarios in which a process is used for placing a delayed ad cookie on the Internet browser of an end-user. The placement of the delayed ad cookie on the Internet browser of the end-user is an update to the end-user cookie made by the ad serving system 240 once the end-user is loading the pixel that the Web server 202 is sending to the end-user browser. Specifically, FIG. 3A and FIG. 3B illustrate scenarios in which the present targeting event marketplace 100 is used to place a delayed ad cookie on the Internet browser of an end-user. FIG. 3A is specific to the situation where travel data is used, and FIG. 3B is specific to the situation where financial data is used.

It should be noted that any process descriptions or blocks in flowcharts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

Referring to FIG. 3A, the flowchart 300 of which exemplifies the situation where travel data is used, as is shown by block 302, the first end-user U1 visits the travel Web site S1. Web site S1 loads the ETEtag as part of its Web page (block 304). The ETEtag calls the ETEserver 202 from the first end-user U1 Internet browser (block 306). Specifically, the ETEtag is an HTML, JavaScript, or similar call that loads a uniform resource locater (URL) from the Web server 202 over HTTP. As is shown by block 308, the ETEserver 202 then analyzes the end-user request and checks with various ad serving systems 240, one of which is ad serving system A1, if the ad server systems have interest in travel related end-users.

In the present example, the ad serving system A1 shows an interest in travel related end-users and places a bid for access to the Internet browser of travel related end-users (block 310). Since one having ordinary skill in the art would be familiar with automatic bidding systems, the process of placing and accepting a bid is not described in additional detail herein. The ETEserver 202 then allows the ad serving system A1 to place a delayed ad cookie on the Internet browser of the end-user U1 (block 312). As was previously mentioned, the ETEtag is the initial code that triggers the Web server 202. Alternatively, the cookie is the result of the process of triggering the Web server 202, where the Web server 202 distributes a pixel for each serving system 240. Once the pixel is loaded to the end-user browser, the serving system 240 updates a cookie and virtually creates the delayed-ad.

Some time later, as shown by block 314, the first end-user U1 visits the general news Web site S3. The Web site S3 communicates with the ad serving system A1 in order to display an ad to the first end-user U1 (block 316). The ad serving system A1 then reads the cookie on the Internet browser of the first end-user U1 and identifies that the first end-user U1 has a travel related delayed ad (block 318). The ad serving system A1 then sends a travel related ad to the first end-user U1 (block 320). The ad serving system A1 then reports to the ETEgateway 230 that targeting event attributes were used and the central database 102 is updated with the ad revenue details (block 322). The owner of the Web site S1 then receives a portion of the ad revenue reported by the ad serving system A1 (block 324).

Referring now to FIG. 3B, the flowchart 350 of which exemplifies the situation where financial data is used, the second end-user U2 visits the finance Web site S2 (block 352). The finance Web site S2 loads the ETEtag as part of its Web page (block 354). The ETEtag calls the ETEserver 202 from the second end-user U2 Internet browser (block 356). As is shown by block 358, the ETEserver 202 then analyzes the end-user request and checks with various ad serving systems 240, one of which is the ad serving system A1, if the ad server systems 240 have interest in finance related end-users.

In the present example, the ad serving system A1 shows an interest in finance related end-users and places a bid for access to the Internet browser of the finance related end-users (block 360). The ETEserver 202 then allows the ad serving system A1 to place a delayed ad cookie on the Internet browser of the second end-user U2 (block 362).

Some time later, as shown by block 364, the second end-user U2 visits the general news Web site S3. The Web site S3 communicates with ad serving system A1 in order to display an ad to the second end-user U2 (block 366). The ad serving system A1 then reads the cookie on the Internet browser of the second end-user U2 and identifies that the second end-user U2 has a finance related delayed ad (block 368). The ad serving system A1 then sends a finance related ad to the second end-user U2 (block 370). The ad serving system A1 then reports to the ETEgateway 230 that targeting event attributes were used and the central database 102 is updated with the ad revenue details (block 372). The owner of the Web site S2 then receives a portion of the ad revenue reported by the ad serving system A1 (block 374).

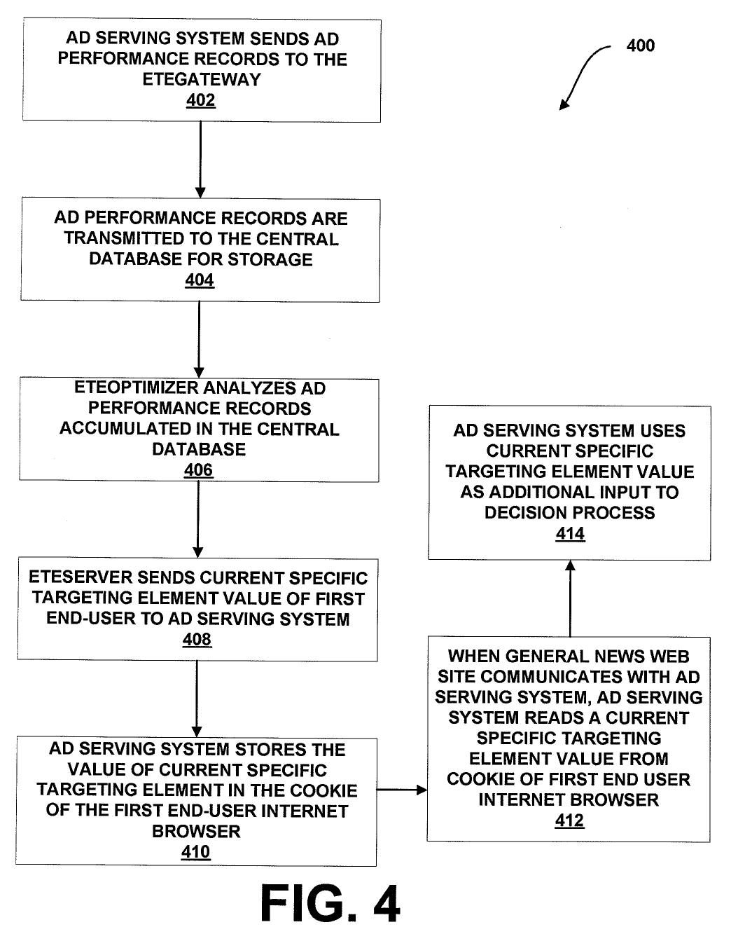

In accordance with the present invention, the advertisement marketplace 100 may add additional targeting data to the ad serving decision process. This process enhances the ad placement process and allows the ad serving systems 240 to use additional targeting elements as inputs to their decision process. The process of adding additional targeting data to ad serving decision process is further illustrated by the flowchart 400 of FIG. 4. It should be noted that FIG. 4 is intended to be a continuation, or extension of FIG. 3A and/or FIG. 3B.

As is shown by block 402 of FIG. 4, the ad serving system 240 A1 sends ad performance records to the ETEgateway 230. The ad performance records are based on real-time and/or offline reports of ad campaign performances received from the ad serving system or logged separately by a dedicated logging system. In accordance with the present invention, an ad performance report may include a number of clicks, ad impressions, and conversion data, where conversion data includes a count of end-user actions or acquisitions defined as the goal of an ad campaign, by ad campaign and data source and may include ad related data such as time of day, frequency of ad display, geolocation, the Web site the ad was displayed on. It should be noted that it is preferred that the ad performance records can be tracked back, using an identifier, to a specific data provider, such as a targeted publisher, to a specific targeting group and to specific targeting elements identified by the marketplace. The ad performance records are then transmitted to the central database 102 for storage (block 404) or to any other dedicated repository.

The ETEoptimizer 250 then analyzes ad performance records accumulated in the central database 102 (block 406). During analyzing of ad performance records, the ETEoptimizer 250 is capable of identifying that a specific targeting element E1, or a specific combination of targeting elements, has a significant prediction regarding performance of ads distributed by the ad serving system 240 A1. It should be noted that known statistical algorithms may be used to determine which targeting element or data provider has a better success rate in predicting ad campaign success. Since such statistical algorithms would be known to those having ordinary skill in the art, further description of the statistical algorithms is not provided herein. It should be noted that while the statistical processing may be performed internally by the ETEoptimizer 250, the statistical processing may instead by performed by an external statistical system, software, module, or service that will have access to the data.

The ETEoptimizer 250 is also capable of analyzing the ad performance records accumulated in the central database 102 to determine a success rate of advertisements for specific groups of end-users. By determining an advertisement success rate specific to groups of end-users, groups of end-users may be rated based on response to advertisements. Such rating of end-users allows for bidding on specific groups of end-users, where the right to provide groups having higher response rates to advertisements may demand a higher bid than providing the same advertisements to groups that have a lower response rate. As an example, a first group of end-users may be end-users that visit a first Web site, while a second group of end-users may be end-users that visit a second Web site. There are many other ways to group end-users.

As shown by block 408, while allowing the ad serving system 240 A1 to place a delayed ad cookie, the ETEserver 202 sends the current specific targeting element E1 value of the first end-user U2 to the ad serving system 240 A1. In addition to the placement of the delayed ad cookie on the Internet browser of the first end-user U1, the ad serving system 240 A1 stores the value of the current specific targeting element E1 in the cookie of the first end-user U1 (block 410).

Thereafter, when the general news Web site S3 communicates with the ad serving system A1, in addition to the reading of the delayed ad from the cookie, the ad serving system 240 A1 reads a current specific targeting element E1 value from the cookie of the first end-user U1 Internet browser (block 412). As is shown by block 414, in order to determine what will be the best performing ad to send to the first end-user U1, the ad serving system 240 A1 uses the current specific targeting element E1 value as additional input to the decision process. Specifically, the ad serving system 240 has a decision engine for choosing the most suitable ad for an end-user.

The process of choosing the most suitable ad is the decision process or the learning process of the ad serving system 240, performed by the decision engine of the ad serving system. The decision process maximizes performance of ad campaigns and insures that, for each end-user, the ad serving system 240 will choose the best performing ad. This process uses a fixed set of parameters, such as, but not limited to, end-user Internet Protocol (IP) address, Web site URL, time of day, and frequency of ads, available for the decision engine when the browser of the end-user requests an ad. The present targeting event marketplace 100 adds to this set of parameters additional information from the targeting elements that have been identified for the end-user. The additional information/data is not available to the decision engine of the ad serving system 240 and in many cases may better predict the success of an ad campaign than the fixed set of parameters to which the decision engine of the ad serving system 240 is limited to. Based on output of the statistical process, the ad serving system 240 obtains the best performing combinations to be used in the decision process.

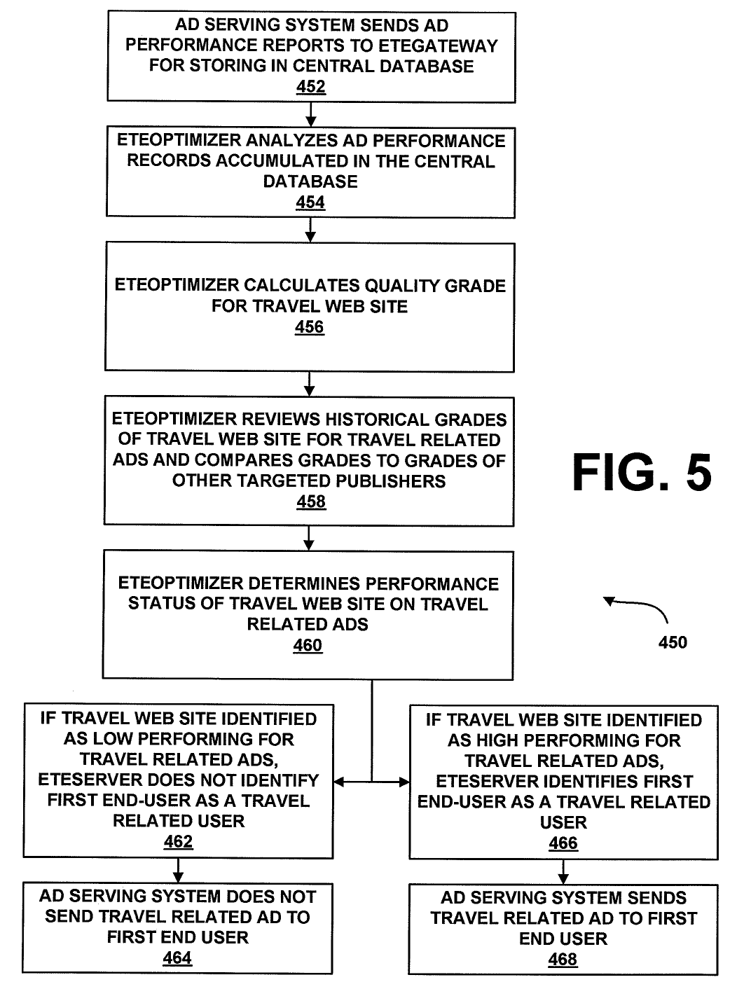

The targeting event marketplace 100 of the present invention also provides a process for reviewing and measuring the targeting quality of Web sites used for the delayed ad placement. FIG. 5 is a flowchart 450 illustrating steps taken by the present advertisement marketplace 100 to ensure targeting quality of the Web site.

Referring to FIG. 5, recalling that variable S1 represents a Web site associated with travel, the ad serving system 240 A1 sends ad performance reports to the ETEgateway 230 (block 452) for storing in the central database 102. The ETEoptimizer 250 then analyzes ad performance records accumulated in the central database 102 (block 454). The ETEoptimizer 250 then calculates quality grade for the travel Web site S1 (block 456).

In accordance with the present invention, quality grade for a Web site is calculated on a periodic basis using guidelines such as the following guidelines: calculate average click through rate (CTR) and conversion rate for each ad campaign; calculate CTR and conversion rate for each ad campaign and Web site combination; calculate CTR and conversion rate for each ad campaign and target group combination; calculate a relative CTR and conversion rate grade for each campaign-site and campaign-group using the average CTR and conversion rate; calculate the grade for each T-pub; calculate the grade for each Web site; and calculate the grade for each group using a weighted average of ad campaign grades, with the campaign ad imprs counts being the weight.

The ETEoptimizer 250 reviews historical grades of the travel Web site S1 for travel related ads and compares the grades to the grades of other targeted publishers (e.g., placement Web sites) (block 458). The ETEoptimizer 250 then determines the performance status of the travel Web site S1 on travel related ads (block 460). If during the performance review, the travel Web site S1 was identified as low performing for travel related ads, the ETEserver 202 does not identify the first end-user U1, visiting the travel Web site S1, as a travel related end-user (block 462). In addition, the ad serving system 240 A1 does not send a travel related ad to the first-user U1 (block 464).

Alternatively, if during the performance review, Web site S1 was identified as high performing for travel related ads, the ETEserver 202 identifies the first end-user U1, visiting the travel Web site S1, as a travel related-user (block 466). The ad serving system A1 then sends a travel related ad to the first end-user U1 (block 468).

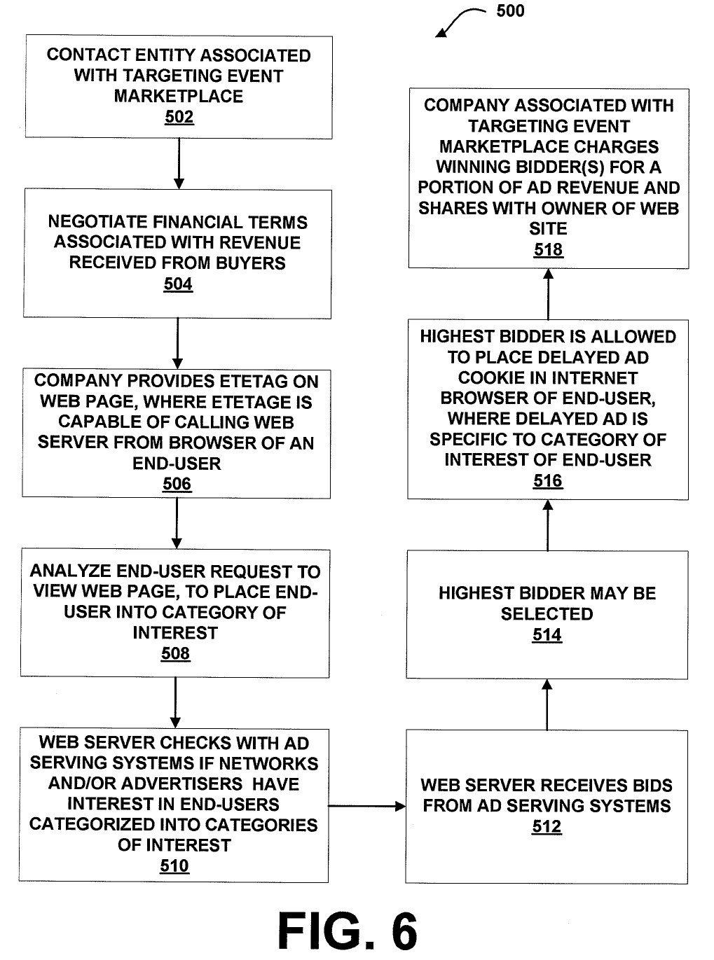

FIG. 6 is a flowchart 500 further illustrating the process of using the present targeting event marketplace 100 in accordance with the first exemplary embodiment of the invention. Referring to FIG. 6, a targeted publisher who wishes to receive advertising revenue from buyers that at least have access to the Internet browser of an end-user, contacts an entity, such as an individual or a company (hereafter, company), associated with the targeting event marketplace 100 (block 502). For exemplary purposes, FIG. 6 describes the targeted publisher as being an owner of a Web site, however, one having ordinary skill in the art would appreciate that the targeted publisher can be other than a Web site owner. During communication with the company associated with the targeting event marketplace 100, the company and the owner of the Web site negotiate financial terms associated with the revenue received from buyers that at least obtain access to the Internet browser of an end-user (block 504). It should be noted that the step of contacting the company may be performed by any form of communication known to those having ordinary skill in the art.

The company then provides the ETEtag on the Web page, where the ETEtag is capable of calling the Web server 202 from the browser of an end-user (block 506). An end-user request to view the Web page is then analyzed by the Web server 202 to place the end-user into a category of interest (block 508). An example of a category of interest may be, but is not limited to, travel, or finance.

The Web server 202 then checks with various ad serving systems 240 to determine if networks and/or advertisers associated with the ad serving systems 240 have interest in end-users categorized into the categories of interest (block 510). As an example, to process an end-user call, based on targeting inputs transferred from the end-user, the Web server 202 looks for a category of interest (channel) match. Once a channel match is found, the matching targeting pixels are identified for each serving system 240. It should be noted that the process of determining if advertisers have interest in the end-users may either be performed by using the network as a midpoint or directly by interacting with the advertisers, as described herein.

To identify matching targeting pixels for each serving system the following steps may be followed. Targeting elements may be reviewed and there may be a search for a targeting group match. It should be noted that each targeting element is adequate for a match. For URLs, a search is performed for category match and base URL match. For keywords, a search is made for a keyword match. A search engine is identified for keywords and a contextual engine is identified for contextual categories. A final match list of groups is then created and the final match list is filtered to negate the option of keywords, URLs, and attributes. For each group on the final match list, the relevant channel and targeting pixel is identified on all active serving systems 240. Each targeting pixel represents a targeting channel or a delayed ad on a specific serving system.

The Web server 202 then receives bids from ad serving systems 240 for obtaining access to the Internet browser of an end-user visiting the Web page (block 512). A highest bidder may be allowed to obtain access to the Internet browser of the end-user (block 514). Of course, other criteria may be used in selecting the bidder that may be provided access to the end-user's Internet browser, and such situations are considered as part of the present invention. During selecting of a bidder, a targeting auction is performed for all of the identified targeting pixels and a winning bid is selected. An identifier is then allocated that uniquely identifies the T-pub, site, and targeting group combination. Additional targeting attributes are identified to be used by each serving system decision process.

It should be noted that a bidder seeking access to the Internet browser of the end-user might not be a network, as previously described. Instead, the bidder may be any party that is seeking information that may be provided once the bidder has access to the Internet browser of the end-user.

As is shown by block 516, in accordance with the present example, the highest bidder is allowed to place a delayed ad cookie in the Internet browser of the end-user, where the delayed ad is specific to the category of interest of the end-user. The company associated with the targeting event marketplace 100 charges the winning bidder or bidders for a portion of the ad revenue and shares it with the owner of the Web site, as originally agreed upon (block 518).

In accordance with an alternative embodiment of the invention, channel optimization may be performed. Specifically, new Web sites are initially tested for the channel declared in a marketplace creation process, which may either be declared by a Web site owner or identified manually the first this that the Web site joins the marketplace. A tested Web site is included in the testing targeting group of the channel and restricted to specific types of campaigns with limited volume. After the initial testing period, the Web site is marked as verified or failed for the channel. The volume of the verified sites will be increased and the failed Web sites will be eliminated from the channel. The channel optimization process tracks changes in the Web sites and target groups quality grades, and identifies the required targeting changes in order to increase performance. The process may include the steps of: removing low performance Web sites from the relevant targeting groups and channels; removing failed Web sites from tested targeting groups; transferring successful sites from tested targeting groups to verified groups; allocating limited volume of end-users from each site to be tested on new channels; and identifying, under-performing campaigns, in specific targeting groups or channels and rearrange targeting groups and channels to allow better campaign targeting. Each channel is defined with a small number of instances based on the targeting quality, which ranges from basic to premium. The Web site testing process promotes verified sites from lower quality instance to the higher qualities. On each quality level, the Web site will be tested and, where warranted based on the performance results, the Web site will be promoted to the next level.

In accordance with another alternative embodiment of the invention, the present marketplace also provides the capability of ensuring that T-pubs accurately place ETEtags on correct Web sites. Specifically, the present marketplace prevents a T-pub from placing an ETEtag on an incorrect Web site simply to increase revenue associated with Web site traffic. By examining a click-through ratio or conversion ratio for advertisements run through the Internet browser of the end-users, the marketplace can determine if an ETEtag was placed on the correct Web site. If the click-through ratio or conversion ratio is very low, an administrator associated with the marketplace may suspect that the advertisements are in fact not being provided to an end-user that is interested in the category of interest. It should be noted that the above functionality may be performed automatically by the optimization engine 250.

In accordance with another alternative embodiment of the invention, the present marketplace may provide access to buyers without requiring a bidding process. Specifically, all buyers that pay a predefined fee may be provided with access to the Internet browser of the end-user.

It should be emphasized that the above-described embodiments of the present invention are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A method for providing a targeting event marketplace, comprising the steps of:
at least one targeted publisher and a targeting event marketplace entity agreeing to financial terms associated with revenues received from at least one buyer that obtains access to the Internet browser of an end-user;
providing an end-user tag on a Web page of the Web site, wherein the end-user tag is capable of calling a Web server from an Internet browser of the end-user;
analyzing an end-user action associated with the Web page, wherein the step of analyzing is performed to categorize the action into a category of targeting event;
the Web server determining if at least one buyer has interest in at least one end-user taking an action that is categorized into at least one category of targeting event; and
receiving bids from at least one buyer for providing access to the Internet browser of the end-user and selecting at least one buyer.

2. The method of claim 1, further comprising the step of the targeting marketplace entity sharing a portion of ad revenue received from at least one buyer with the at least one targeted publisher.

3. The method of claim 1, wherein the step of determining if at least one buyer has interest is further defined by the step of the Web server checking with ad serving systems if the at least one buyer has interest.

4. The method of claim 1, wherein the step of receiving bids is performed by the Web server.

5. The method of claim 1, wherein the step of selecting at least one buyer is performed by automatically selecting a highest bidder.

6. The method of claim 1, further comprising the step of testing the at least one buyer to determine a level of performance with at least one ad campaign that is achieved by the at least one buyer.

7. The method of claim 6, further comprising the step of removing at least one targeted publisher from the targeting event marketplace if the at least one targeted publisher is not performing at a minimal performance level.

8. The method of claim 6, further comprising the step of using a statistical analysis to determine which parameter of a series of parameters has a better success rate in predicting ad campaign success.

9. The method of claim 1, wherein providing access to the Internet browser of the end-user is provided by writing back a pixel call to the end-user Internet browser.

10. The method of claim 1, further comprising the step of allowing the selected at least one buyer to use the access to the Internet browser of the end-user to place a delayed ad cookie in the Internet browser of the end-user, where the delayed ad cookie is specific to the category of the targeting event of the end-user.

11. The method of claim 1, further comprising the step of allowing the selected at least one buyer to use the access to the Internet browser of the end-user to read data from the Internet browser of the end-user, such that where the data that is read is attributed to the category of the targeting event of the end-user.

12. The method of claim 1, wherein a network allows at least one client of the network to show interest in the at least one end-user, by allowing the client of the network to provide bids for placing the delayed ad cookie in the Internet browser of the end-user.

13. The method of claim 12, wherein the at least one client of the network is at least one advertiser.

14. The method of claim 1, further comprising the step of rating each targeted publisher associated with the targeting event marketplace, wherein each targeted publisher is rated based on success of advertisements targeted according to targeting events that are based on that targeted publisher.

15. The method of claim 14, further comprising the step of manually or automatically setting a specific bid price to each targeted publisher based on rating of the targeted publisher.

16. The method of claim 1, further comprising the step of analyzing influence of various targeting parameters to better predict success of an advertisement campaign for the end-user.

17. The method of claim 1, wherein the end-user action is selected from the group consisting of viewing the Web page, searching via the Web page, clicking on an item in the Web page, and data entry.

18. The method of claim 1, wherein the targeted publisher is an owner of the Web site.

19. A method for interacting in a targeting event marketplace, comprising the steps of:
an end-user visiting a Web site;
the Web site loading an end-user tag that calls a Web server from an Internet browser of the end-user;
analyzing actions of the end-user associated with the Web page, wherein the step of analyzing is performed to categorize the action into a category of targeting event;
the Web server determining if at least one buyer has interest in at least one end-user taking an action that is categorized into at least one category of targeting event; and
the at least one buyer bidding for a right to obtain access to the Internet browser of the end-user.

20. The method of claim 19, wherein the end-user action is selected from the group consisting of viewing the Web page, searching via the Web page, clicking on an item in the Web page, and data entry.

21. The method of claim 19, further comprising the step of a targeted publisher sharing a portion of ad revenue received, with a targeting event marketplace entity.

22. The method of claim 19, wherein the step of determining if at least one buyer has interest is further defined by the step of the Web server checking with ad serving systems if the at least one buyer has interest.

23. The method of claim 19, wherein receiving bids is performed by the Web server.

24. The method of claim 19, further comprising the step of selecting at least one buyer.

25. The method of claim 24, wherein the step of selecting at least one buyer is performed by automatically selecting a highest bidder.

26. The method of claim 24, further comprising the step of testing the at least one buyer to determine a level of performance with at least one ad campaign that is achieved by the at least one buyer.

27. The method of claim 26, further comprising the step of using a statistical analysis to determine which parameter of a series of parameters has a better success rate in predicting ad campaign success.

28. The method of claim 19, wherein providing access to the Internet browser of the end-user is provided by writing back a pixel call to the end-user Internet browser.

29. The method of claim 24, further comprising the step of allowing the selected at least one buyer to use the access to the Internet browser of the end-user to place a delayed ad cookie in the Internet browser of the end-user, where the delayed ad cookie is specific to the category of the targeting event of the end-user.

30. The method of claim 24, further comprising the step of allowing the selected at least one buyer to use the access to the Internet browser of the end-user to read data from the Internet browser of the end-user, such that where the data that is read is attributed to the category of the targeting event of the end-user.

31. The method of claim 19, wherein a network allows at least one client of the network to show interest in the at least one end-user, by allowing the client of the network to provide bids for placing the delayed ad cookie in the Internet browser of the end-user.

32. The method of claim 31, wherein the at least one client of the network is at least one advertiser.

33. The method of claim 19, further comprising the step of analyzing influence of various targeting parameters to better predict success of an advertisement campaign for the end-user.

34. The method of claims 19, where the targeted publisher is an owner of the Web site.

35. A method for providing a targeting event marketplace, comprising the steps of:
at least one targeted publisher and a targeting event marketplace entity agreeing to financial terms associated with revenues received from at least one buyer that obtains access to the Internet browser of an end-user;
providing an end-user tag on a Web page of the Web site, wherein the end-user tag is capable of calling a Web server from an Internet browser of the end-user;
analyzing an end-user action associated with the Web page, wherein the step of analyzing is performed to categorize the action into a category of targeting event;
the Web server determining if at least one buyer has interest in at least one end-user taking an action that is categorized into at least one category of targeting event; and
providing the at least one buyer with access to the Internet browser of the end-user for a predefined fee.
